(19) United States
(12) Patent Application Publication
(10) Pub. No.: US 2014/0134710 A1
(43) Pub. Date: May 15, 2014

(54) SYSTEM FOR THE TREATMENT AND PURIFICATION OF BIOGAS WITH ELIMINATION OF AIRFLOW FROM A SCRUBBER SYSTEM

(71) Applicant: Jeffrey J. Grill, Long Beach, CA (US)

(72) Inventor: Jeffrey J. Grill, Long Beach, CA (US)

(21) Appl. No.: 13/673,938

(22) Filed: Nov. 9, 2012

(51) Int. Cl. B01D 53/14

(52) U.S. Cl. CPC B01D 53/1425
USPC 435/266; 96/234; 95/175; 435/283.1

(57) ABSTRACT

Systems and methods are presented for the purification of a biogas. The systems comprise: a gas processor for reducing CO₂, volatile organic compounds, and H₂S in the biogas, the gas processor comprising a scrubber tank and a scrubber liquid; and a scrubber liquid processor in fluid connection with the gas processor for reducing the amount of absorbed gas in the scrubber liquid. The scrubber liquid processor comprises a stripper tank, and is configured to reduce or eliminate airflow through the stripper tank.

### FIELD OF THE INVENTION

The invention broadly relates to systems for the treatment and purification of biogas.

### BACKGROUND OF THE INVENTION

Biogas refers to a gaseous fuel produced by the biological breakdown of organic matter in the absence of oxygen. It is produced by the anaerobic digestion or fermentation of biodegradable materials such as biomass, manure, sewage, municipal waste, green waste, plant material and crops. Biogas primarily comprises methane (CH₄) and carbon dioxide (CO₂), and may contain small amounts of hydrogen sulfide (H₂S), moisture (H₂O) and siloxanes.

The gases methane, hydrogen, carbon monoxide, and any other hydrocarbon (e.g., ethane, propane, butane, etc.) can be combusted or oxidized with oxygen. This energy release allows biogas to be used as a fuel. Biogas can be used as a fuel for any heating purpose. It can also be produced by anaerobic digesters where it is typically used in a gas engine to convert the chemical energy of the gas into electricity and heat. Anaerobic digestion is a series of processes in which microorganisms break down biodegradable material in the absence of oxygen, also used for industrial or domestic purposes to manage waste and/or to release energy.

The digestion process begins with bacterial hydrolysis of the input materials in order to break down insoluble organic polymers such as carbohydrates and make them available for other bacteria. Acidogenic bacteria then convert the sugars and amino acids into carbon dioxide, hydrogen, ammonia, and organic acids. These bacteria then convert these resulting organic acids into acetic acid, along with additional ammonia, hydrogen, and carbon dioxide. Finally, methanogens convert these products to methane and carbon dioxide.

Anaerobic digesters can use a multitude of feed stocks for the production of methane rich bio-gas including but not limited to purpose-grown energy crops such as maize. Landfills also produce methane rich bio-gas through the anaerobic digestion process. As part of an integrated waste management system, this bio-gas may be collected and processed for beneficial use while simultaneously reducing greenhouse gas emissions into the atmosphere.

Anaerobic digestion is widely used as a source of renewable energy. The process produces a biogas that can be used directly as cooking fuel, in combined heat and power gas engines or upgraded to natural gas quality biomethane. The utilization of biogas as a fuel helps to replace fossil fuels. The nutrient-rich digestate and/or Leachate that is also produced can be used as fertilizer.

H₂S is a common contaminant in biogas applications such as landfills and digesters. Previously, biological H₂S systems have been used for the removal of H₂S from such biogas applications. In some cases, biological H₂S removal systems can be several orders in magnitude lower in cost than expensive sulfur removal systems such as media or iron chelating systems. However, conventional biological systems can require more than 2% oxygen to maintain a stable removal rate of H₂S, and most raw gas from landfills and digesters contains far less than 2% oxygen. Accordingly, the raw gas from landfills and digesters cannot be processed using a conventional biological H₂S removal system due to the scarcity of oxygen.

In biogas applications such as landfills and digesters, H₂S and other impurities including halides and halogenated compounds are frequently present in low percent to ppm/ppb quantities. These compounds may dissociate at high temperatures and in the presence of water to form caustic acids including, but not limited to H₂S, HF, H₂SO₄, H₃PO₄ and HNO₃. Typical metallurgy such as carbon and stainless steels are susceptible to corrosion and failure when placed into contact with these acids. Downstream equipment that changes the dew point and allows condensation to occur may concentrate these acids in pooling areas such as moisture separators, chillers, and gas coolers.

Gas processing techniques and other unit operations may produce acids from gas constituents. However, these systems merely employ acid neutralization after the acids have formed and concentrated in the pooling areas. As such, these conventional systems simply act as a band aid to condensation. Caustic scrubbers have been used in the past for several applications. For example, they may be used for CO₂ removal, H₂S removal and also for the removal of several other reactive contaminants in both liquid and gaseous phase.

Scrubbing is commonly used to remove CO₂ and H₂S from biogas, as these gasses have higher solubility in certain liquids, such as water or polyethylene glycol, than in methane. The absorption process in such scrubbers is purely physical. An exemplary system involves pressurizing and feeding biogas into the bottom of a scrubber column while the scrubber liquid is fed to the top of the scrubber column so that absorption can occur in a counter-current flow. The scrubber liquid then exits the bottom of the scrubber column with absorbed CO₂ and/or H₂S. The contaminated scrubber liquid may then be regenerated (i.e., the CO₂ and/or H₂S is removed from the scrubber liquid) and recirculated back into the absorption column. Regeneration of the scrubber liquid is typically accomplished by stripping the absorbed CO₂ and/or H₂S with air in a second column (sometimes known as a stripper column) operating in much the same fashion as the scrubber column.

The off-gas outflow from the stripper column then contains constituents of the input air flow, enriched in CO₂, H₂S, and often a trace amount of CH₄ (absorbed by the scrubber liquid when in contact with the biogas). It is highly undesirable to release CH₄ into the environment; however, because CH₄ in the off-gas has been diluted in air used in the stripping process, efficiently combusting or oxidizing the off-gas can be problematic, even potentially requiring additional fuel to sustain a flame or thermal oxidizer process.

### SUMMARY OF THE INVENTION

An embodiment of the present invention is directed toward a system for the purification of biogas, the system comprising: a gas processor for reducing CO₂, volatile organic compounds, and H₂S in the biogas, the gas processor comprising a scrubber tank and a scrubber liquid; and a scrubber liquid processor in fluid connection with the gas processor for reducing the amount of absorbed gas in the scrubber liquid, the scrubber liquid processor comprising: a stripper tank; an off-gas pump configured such that the contents of the stripper tank are subjected to a negative pressure and off-gas is removed from the stripper tank; and off-gas piping configured to divert a portion of the off-gas flow and reintroduce the diverted off-gas flow into the stripper tank such that the reintroduced off-gas flow passes through scrubber liquid contained in the stripper tank.

In some embodiments, the system further comprises a biological sulfur removal system configured to receive non-diverted off-gas flow from the off-gas pump. In some related embodiments, the biological sulfur removal system comprises air piping configured to allow metered addition of air to the off-gas flow prior to biological sulfur removal.

In some embodiments, the system further comprises a regenerative thermal oxidizer, non-regenerative thermal oxidizer, flame, or engine for oxidation or combustion of residual methane in a non-diverted portion of the off-gas flow.

In some embodiments, the scrubber liquid processor further comprises an agitation device located in the stripper tank, and wherein the agitation device is configured to agitate scrubber liquid contained in the stripper tank. In some related embodiments, the agitation device comprises one or more mechanical agitation devices selected from the group consisting of a propeller, an impellor, and a turbine. In these embodiments, the mechanical agitation device is in contact with the scrubber liquid in the stripper tank.

In some embodiments, the scrubber liquid processor further comprises a second pump system in fluid communication with the stripper tank. In these embodiments, the second pump system is configured to remove scrubber liquid from the stripper tank and reintroduce the removed scrubber liquid to the stripper tank in such a way as to agitate the remaining scrubber liquid contained in the stripper tank. In some related embodiments, the second pump system is configured to reintroduce the removed scrubber liquid to the stripper tank through one or more eductors, nozzles, or other fluid flow regulation devices.

In some embodiments, the scrubber liquid processor further comprises a third pump system in fluid communication with the stripper tank, wherein the third pump system is configured to remove a portion of the scrubber liquid from the stripper tank and reintroduce the removed scrubber liquid to the stripper tank as droplets at some position above the level of scrubber liquid remaining in the stripper tank. In some related embodiments, the third pump system comprises one or more nozzles or other fluid flow regulation devices through with the reintroduced scrubber liquid is passed to form droplets in the stripper tank.

In some embodiments, the scrubber liquid processor further comprises a fourth pump system in fluid communication with the scrubber tank and the stripper tank, wherein the fourth pump system is configured to transport scrubber liquid from the scrubber tank to the stripper tank after CO₂, volatile organic compounds, and H₂S have been absorbed by the scrubber liquid. In some related embodiments, the fourth pump system is configured to introduce scrubber liquid into the stripper tank as droplets at some position above the level of scrubber liquid in the stripper tank. In some further related embodiments, the fourth pump system comprises one or more nozzles or other fluid flow regulation devices through with the scrubber liquid is passed to form droplets in the stripper tank.

Another embodiment of the present invention is directed toward a system for the purification of biogas, the system comprising: a gas processor for reducing CO₂, volatile organic compounds, and H₂S in the biogas, the gas processor comprising a scrubber tank and a scrubber liquid; and a scrubber liquid processor in fluid connection with the gas processor for reducing the amount of absorbed gas the scrubber liquid, the scrubber liquid processor comprising: a stripper tank; an off-gas pump configured such that the contents of the stripper tank are subjected to a negative pressure and off-gas is removed from the stripper tank; and an agitation device located in the stripper tank. In these embodiments, the agitation device is configured to agitate scrubber liquid contained in the stripper tank.

In some embodiments, the agitation device comprises one or more mechanical agitation devices. In some further related embodiments, the one or more mechanical agitation devices are selected from the group consisting of a propeller, an impellor, and a turbine. In these embodiments, the one or more mechanical agitation devices are in contact with the scrubber liquid in the stripper tank.

Another embodiment of the present invention is directed toward a system for the purification of biogas, the system comprising: a gas processor for reducing CO₂, volatile organic compounds, and H₂S in the biogas, the gas processor comprising a scrubber tank and a scrubber liquid; and a scrubber liquid processor in fluid connection with the gas processor for reducing the amount of absorbed gas the scrubber liquid, the scrubber liquid processor comprising: a stripper tank; an off-gas pump configured such that the contents of the stripper tank are subjected to a negative pressure and off-gas is removed from the stripper tank; and a second pump system in fluid communication with the stripper tank, wherein the second pump system is configured to remove scrubber liquid from the stripper tank and reintroduce the removed scrubber liquid to the stripper tank in such a way as to agitate the remaining scrubber liquid contained in the stripper tank. In some embodiments, the second pump system is configured to reintroduce the scrubber liquid to the stripper tank through one or more eductors, nozzles, or other fluid flow regulation devices.

Another embodiment of the present invention is directed toward a system for the purification of biogas, the system comprising: a gas processor for reducing CO₂, volatile organic compounds, and H₂S in the biogas, the gas processor comprising a scrubber tank and a scrubber liquid; and a scrubber liquid processor in fluid connection with the gas processor for reducing the amount of absorbed gas in the scrubber liquid, the scrubber liquid processor comprising: a stripper tank; an off-gas pump configured such that the contents of the stripper tank are subjected to a negative pressure and off-gas is removed from the stripper tank; and a second pump system in fluid communication with the stripper tank, and wherein the second pump system is configured to remove a portion of scrubber liquid from the stripper tank and reintroduce the removed scrubber liquid into the stripper tank as droplets at some position above the level of scrubber liquid remaining in the stripper tank. In some embodiments, the second pump system comprises one or more nozzles or other fluid flow regulation devices through which the scrubber liquid is passed to form droplets in the stripper tank.

Another embodiment of the present invention is directed toward a system for the purification of biogas, the system comprising: a gas processor for reducing CO₂, volatile organic compounds, and H₂S in the biogas, the gas processor comprising a scrubber tank and a scrubber liquid; and a scrubber liquid processor in fluid connection with the gas processor for reducing the amount of absorbed gas in the scrubber liquid, the scrubber liquid processor comprising: a stripper tank; an off-gas pump configured such that the contents of the stripper tank are subjected to a negative pressure and off-gas is removed from the stripper tank; and a second pump system in fluid communication with the scrubber tank and the stripper tank; wherein the second pump system is configured to transport scrubber liquid from the scrubber tank to the stripper tank after CO₂, volatile organic compounds, and H₂S have been absorbed by the scrubber liquid and introduce the scrubber liquid into the stripper tank as droplets at some position above the level of scrubber liquid in the stripper tank. In some embodiments, the second pump system comprises one or more nozzles or other fluid flow regulation devices through which the scrubber liquid is passed to form droplets in the stripper tank.

Another embodiment of the present invention is directed to a method for the purification of biogas, the method comprising: reducing CO₂, volatile organic compounds, and H₂S in biogas by contacting the biogas with a scrubber liquid in a scrubber tank, wherein the scrubber liquid absorbs CO₂, volatile organic compounds, and H₂S from the biogas; transporting the scrubber liquid from the scrubber tank to a stripper tank; subjecting the contents of the stripper tank to a negative pressure to evolve an off-gas containing CO₂, volatile organic compounds, and H₂S, from the biogas; removing the off-gas from the stripper tank; reintroducing a portion of the removed off-gas into the stripper tank such that the reintroduced off-gas passes through scrubber liquid contained in the stripper tank.

In some embodiments, the method further comprises subjecting a portion of the off-gas from the stripper tank to a biological sulfur removal system. In some embodiments, the method further comprises subjecting a portion of the off-gas from the stripper tank to a regenerative thermal oxidizer, non-regenerative thermal oxidizer, flame, or engine for oxidation or combustion of methane in the off-gas.

In some embodiments, the method further comprises agitating scrubber liquid in the stripper tank with one or more mechanical agitation devices. In some related embodiments, the one or more mechanical agitation devices are selected from the group consisting of a propeller, an impellor, and a turbine.

In some embodiments, the method further comprises removing a portion of scrubber liquid from the stripper tank and reintroducing the removed scrubber liquid into the stripper tank in such a way as to agitate the remaining scrubber liquid contained in the stripper tank. In some related embodiments, the removed scrubber liquid is reintroduced into the stripper tank through one or more eductors, nozzles, or other fluid flow regulation devices.

In some embodiments, the method further comprises removing a portion of scrubber liquid from the stripper tank and reintroducing the removed scrubber liquid into the stripper tank as droplets at some position above the level of scrubber liquid remaining in the stripper tank. In some related embodiments, reintroducing the removed scrubber liquid into the stripper tank as droplets comprises pumping the removed scrubber liquid through one or more nozzles or other fluid flow regulation devices to form droplets in the stripper tank.

In some embodiments, transporting the scrubber liquid to a stripper tank comprises introducing scrubber liquid from the scrubber tank into the stripper tank as droplets at some position above the level of scrubber liquid in the stripper tank. In some embodiments, scrubber liquid is introduced into the stripper tank by pumping the scrubber liquid through one or more nozzles or other fluid flow regulation devices to form droplets.

Another embodiment of the present invention is directed to a method for the purification of biogas, the method comprising: reducing CO₂, volatile organic compounds, and H₂S, from biogas by contacting the biogas with a scrubber liquid in a scrubber tank, wherein the scrubber liquid absorbs CO₂, volatile organic compounds, and H₂S from the biogas; transporting the scrubber liquid from the scrubber tank to a stripper tank; subjecting the contents of the stripper tank to a negative pressure and agitation to evolve an off-gas containing CO₂, volatile organic compounds, and H₂S, from the biogas; and removing the off-gas from the stripper tank.

In some embodiments, agitation of the scrubber liquid is accomplished by one or more mechanical agitation devices. In some related embodiments, the one or more mechanical agitation devices is selected from the group consisting of a propeller, an impellor, and a turbine.

In some embodiments, agitation of the scrubber liquid is accomplished by removing a portion of scrubber liquid from the stripper tank and reintroducing the removed scrubber liquid into the stripper tank in such a way as to agitate the remaining scrubber liquid contained in the stripper tank. In some related embodiments, the removed scrubber liquid is reintroduced to the stripper tank through one or more eductors, nozzles, or other fluid flow regulation devices.

Another embodiment of the present invention is directed to a method for the purification of biogas, the method comprising: reducing CO₂, volatile organic compounds, and H₂S, from biogas by contacting the biogas with a scrubber liquid in a scrubber tank, wherein the scrubber liquid absorbs CO₂, volatile organic compounds, and H₂S from the biogas; transporting the scrubber liquid from the scrubber tank to a stripper tank; subjecting the contents of the stripper tank to a negative pressure to evolve an off-gas containing CO₂, volatile organic compounds, and H₂S, from the biogas; removing a portion of scrubber liquid from the stripper tank; reintroducing the removed scrubber liquid into the stripper tank as droplets at some position above the level of scrubber liquid remaining in the stripper tank to further evolve off-gas containing CO₂, volatile organic compounds, and H₂S, from the biogas; and removing the off-gas from the stripper tank. In some embodiments, reintroducing the removed scrubber liquid as droplets comprises pumping the removed scrubber liquid through one or more nozzles or other fluid flow regulation devices to form droplets.

Another embodiment of the present invention is directed to a method for the purification of biogas, the method comprising: reducing CO₂, volatile organic compounds, and H₂S, from biogas by contacting the biogas with a scrubber liquid in a scrubber tank, wherein the scrubber liquid absorbs CO₂, volatile organic compounds, and H₂S from the biogas; transporting the scrubber liquid from the scrubber tank to a stripper tank and introducing the scrubber liquid into the stripper tank as droplets at some position above the level of scrubber liquid in the stripper tank; subjecting the contents of the stripper tank to a negative pressure to evolve an off-gas containing CO₂, volatile organic compounds, and H₂S, from the biogas. In some embodiments, introducing the scrubber liquid into the stripper tank as droplets comprises pumping the scrubber liquid through one or more nozzles or other fluid flow regulation devices in the stripper tank to form droplets.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

FIG. 1 is a flow diagram illustrating the stages of an exemplary anaerobic digestion system.

FIG. 2 is a diagram illustrating the stages of an exemplary landfill gas system.

FIG. 3 is a flow diagram illustrating a system and method for the purification of biogas, in accordance with an embodiment of the invention.

FIG. 4 is a flow diagram illustrating a system and method for the purification of biogas, in accordance with an embodiment of the invention utilizing partial recirculation of an off-gas flow.

FIG. 5 is a flow diagram illustrating a system and method for the purification of biogas, in accordance with an embodiment of the invention utilizing partial recirculation of an off-gas flow and mechanical agitation of scrubber fluid in a stripper tank.

FIG. 6 is a flow diagram illustrating a system and method for the purification of biogas, in accordance with an embodiment of the invention utilizing partial recirculation of an off-gas flow and partial recirculation of scrubber fluid in a stripper tank.

FIG. 7 is a flow diagram illustrating a system and method for the purification of biogas, in accordance with an embodiment of the invention utilizing introduction of scrubber fluid as a collection of droplets and partial recirculation of an off-gas flow in a stripper tank.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s). Additionally, various aspects of certain systems and methods for treatment of biogas described herein may also be found in co-pending and commonly assigned U.S. Utility patent application Ser. No. 13/557,004, the disclosure of which is hereby incorporated by reference in its entirety.

Biogas is a renewable energy composed primarily of methane resulting from the natural decomposition of organic waste by anaerobic bacteria. Similar to natural gas, methane captured by a biogas system can be used to provide heat, electrical power or transportation biofuel. Biogas extraction can be used to: (i) produce green and renewable energy; (ii) reduce pollution and greenhouse gases; (iii) reduce waste odors and pathogens; and transform waste into valuable bio-fertilizer.

Fermentation, or anaerobic digestion, is the most common process that breaks down the organic waste. The organic waste may then be oxidized, thereby creating energy. Various types of organic materials include, but are not limited to: (i) biomass, (ii) landfill waste, (iii) sewage, (iv) manure, and (v) plant material. The most common gases produced are methane and carbon dioxide. Other gases that can be formed include hydrogen, nitrogen, and carbon monoxide. Methane, hydrogen, carbon monoxide and any other hydrocarbon (e.g., ethane, propane, butane, etc.) can be combusted to create heat and electricity. When biogas is created from existing waste streams, it reduces odors and methane emissions and creates two renewable resources. Methane is a potent greenhouse gas that contributes to global climate change. It is expected that a landfill gas energy project will capture about 30% to 99% of the methane emitted from the landfill, depending on system design and effectiveness.

There are two primary methods of recovering biogas for use as energy, namely: (i) by creating an anaerobic digestion system to process waste, most commonly manure or other wet biomass, and (ii) by recovering natural biogas production formed in existing landfills. Once recovered, biogas can be converted to energy using a number of methods.

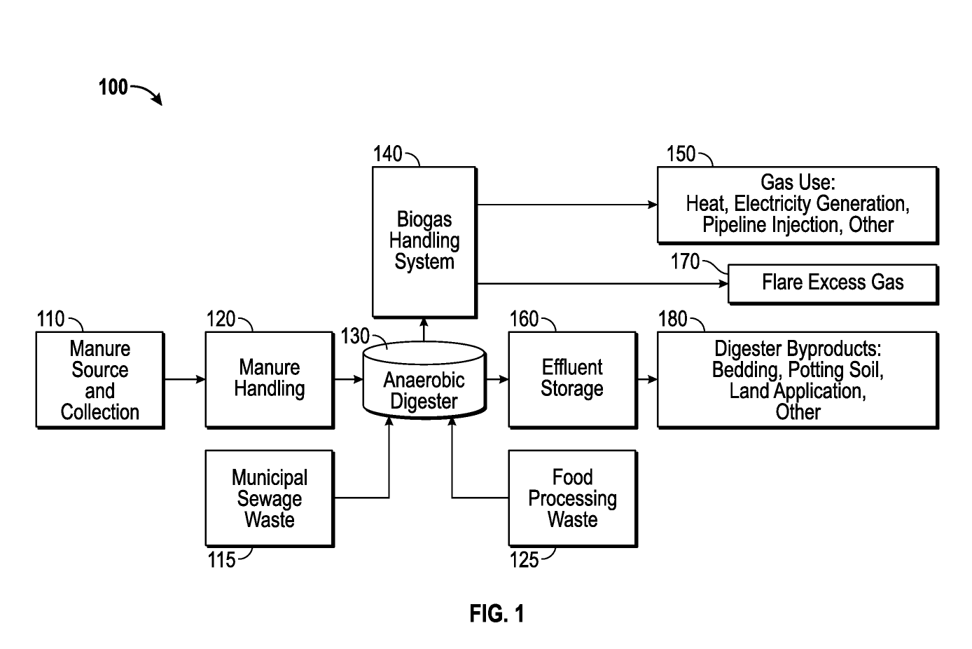

FIG. 1 is a flow diagram illustrating the stages of an exemplary anaerobic digestion system 100. Specifically, the an anaerobic digestion system 100 comprises a manure collection system 110, a manure handling system 120, a municipal sewage waste system 115, a food processing waste system 125, an anaerobic digester 130, a biogas handling system 140, gas use devices 150, an effluent storage 160. In addition, at least one flare 170 may be used to burn excess gas. Digester products 180 may be used for bedding, potting soil, land applications, etc. More particularly, manure collection system 110 is used to gather manure and transport it to the anaerobic digester 130. In some cases, existing liquid/slurry manure management systems can be adapted to deliver manure to the anaerobic digester 130. The anaerobic digester 130 may be designed to stabilize manure and optimize the production of methane. A storage facility for digester effluent, or waste matter, may also be required. In some embodiments, waste from a municipal sewage waste system 115 and/or a food processing waste system 125 is transported and fed into to the anaerobic digester 130.

With further reference to FIG. 1, the anaerobic digester 130 outputs biogas into the biogas handling system 140. The biogas may contain approximately 60% methane and 40% carbon dioxide. It is collected, treated, and piped to a gas use device 150. By way of example, the biogas can then be upgraded to natural gas pipeline quality. It may also be used to generate electricity, as a boiler fuel for space or water heating, or for a variety of other uses. At least one flare 170 is also installed to destroy extra gas and as a back-up mechanism for the primary gas use device 160.

The anaerobic digester 130 may be made out of concrete, steel, brick, or plastic. Additionally, the digester 130 includes a tank for pre-mixing the waste and a digester vessel. In some embodiments, the anaerobic digester 130 may comprise a batch digester or a continuous digester. In embodiments where the anaerobic digester 130 comprises a batch digester, the batch digester is loaded with organic materials, which are allowed to digest therein. The retention time depends on temperature and other factors. Once digestion is complete, the effluent is removed and the process is repeated.

In further embodiments, the anaerobic digester 130 may comprise a continuous digester, wherein organic material is constantly or regularly fed into the digester, and wherein the material moves through the digester either mechanically or by the force of the new feed. Unlike batch digesters, continuous digesters produce biogas without the interruption of loading material and unloading effluent. Various types of continuous digesters include vertical tank systems, horizontal tank or plug-flow systems, and multiple tank systems.

Anaerobic digestion also occurs naturally underground in landfills, wherein the waste is covered and compressed by the weight of the material that is deposited above. This material prevents oxygen exposure, thereby allowing chemical reactions and microbes to act upon the waste. This encourages an uncontrolled process of biomass decay. The rate of production is affected by waste composition and landfill geometry. Landfill gas may comprise about 40% to 60% methane, and about 40% to 60% carbon dioxide.

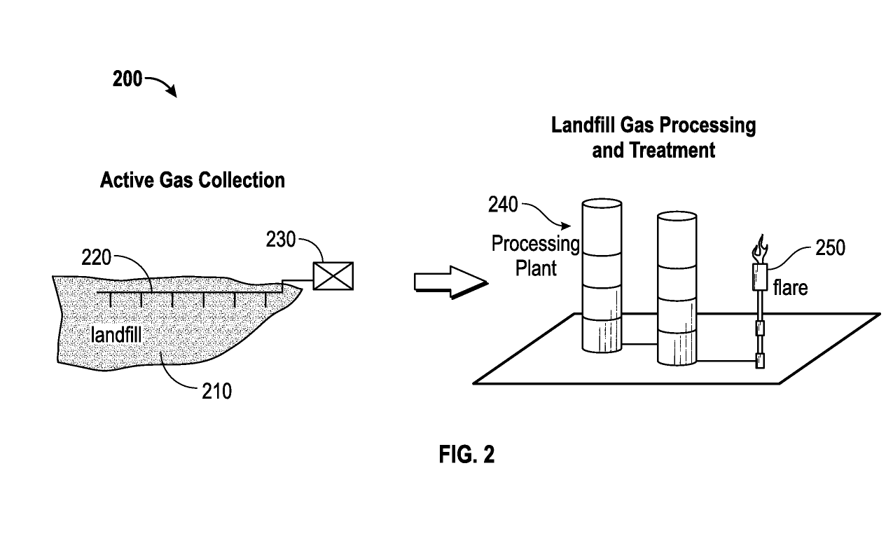

FIG. 2 is a diagram illustrating an exemplary landfill gas system 200 including landfill 210, landfill gas wells 220 for active gas collection, landfill gas wellhead 230, landfill gas processing and treatment plant 240, and at least one landfill gas flare 250. Landfill gas is extracted from landfill 210 using a series of wells 220 and a blower/flare system. The landfill gas system 200 directs the collected gas to landfill gas processing and treatment plant 240, where it is processed and treated.

H₂S is a common contaminant in biogas applications such as landfills and digesters. Previously, biological H₂S systems have been used for the removal of H₂S from such biogas applications. In some cases, biological H₂S removal systems can be several orders in magnitude lower in cost than expensive sulfur removal systems such as media or iron chelating systems. However, conventional biological systems can require more than 2% oxygen to maintain a stable removal rate of H₂S, and most raw gas from landfills and digesters contains far less than 2% oxygen. For example, the oxygen level in a typical raw feed can be around 0.5% oxygen. Accordingly, unadulterated raw gas from landfills and digesters cannot be processed using a conventional biological H₂S removal system due to the scarcity of oxygen.

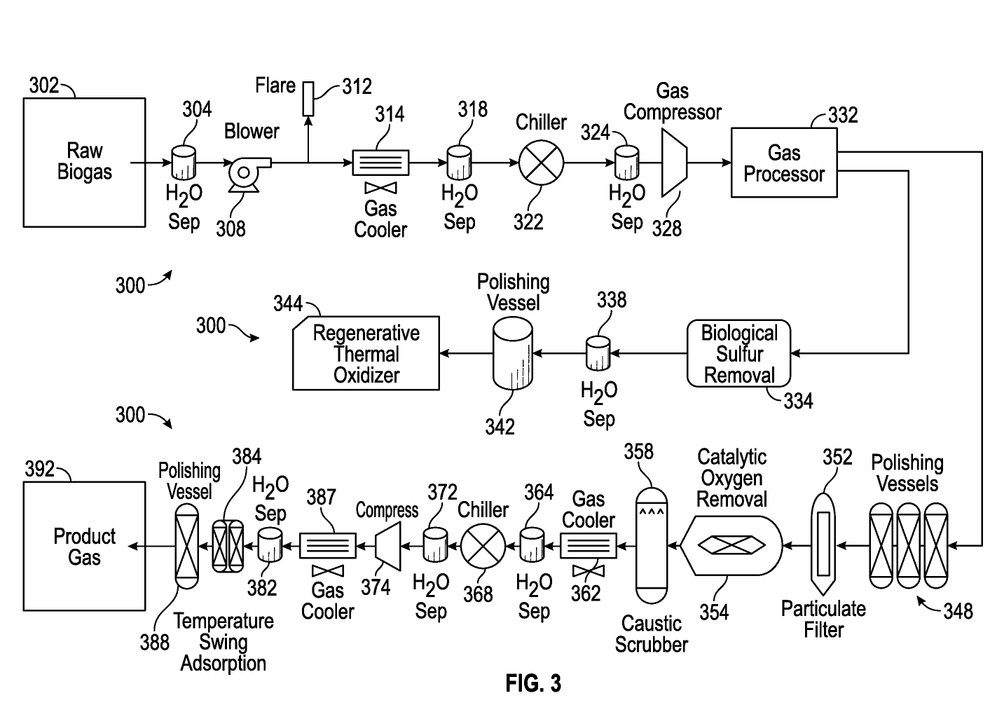

FIG. 3 is a flow diagram illustrating a system and method 300 for the treatment of biogas in accordance with an embodiment of the invention, including optional preprocessing of input biogas and optional post processing of product gas and off-gas. In particular, raw biogas 302 is assumed to be dirty and wet, e.g., when extracted from a landfill or received from a digester. In the illustrated embodiment, the raw biogas 302 is approximately 100° F. and approximately −2 PSIG. Once collected, it passes through a moisture separator 304 comprising a vessel with internal baffling or pads that remove an appropriate and desired amount of moisture from this saturated gas stream. The gas stream then passes through a vacuum blower 308 or compressor which creates suction on the landfill and generates a positive gas pressure for the downstream equipment. This blower 308 can be either centrifugal, positive displacement, or any other configuration that allows for the generation of a positive pressure at the system's discharge. Compression both facilitates drying (dew point change) and drives the flow of gas through the plant.

With further reference to FIG. 3, the gas can be destroyed by a flare 312, sent to an engine for electricity generation, or sent to a gas processing plant, whereby a gas cooler 314 is employed to reduce the gas temperature from the gain of heat through compression. The gas cooler 314 may comprise a tube bank heat exchanger with one or more forced draft fans to cool the gas with ambient air. A moisture separator 318 is then used to remove liquid droplets and condensate from the gas phase. A gas chiller 322 is used to reduce the gas dew point, thereby further removing excess water and particulates. This moisture is removed by another moisture separator 324. The gas is then passed through a gas compressor 328 to increase the pressure of the gas for processing. By way of example, the gas compressor 328 may comprise a positive displacement, flooded screw, sliding vane, or any other type of gas compressor for compressing the gas to the desired level.

The gas is then passed through a gas processor 332, which removes CO₂, volatile organic compounds (VOCs), and H₂S according to the methods described here, thereby concentrating and purifying the CH₄ in the product gas. After removal of CO₂, VOCs, and H₂S, the product gas may optionally be further processed (e.g., as shown in FIG. 3) before being collected for use.

In embodiments of the present invention, the gas processor 332 comprises a scrubber system whereby the gas contacts a scrubber liquid into which the CO₂, volatile organic compounds (VOCs), and H₂S are absorbed. Any appropriate scrubber liquid known in the art may be used. However, water and polyethylene glycol scrubber systems are well known.

In one such exemplary system, unprocessed biogas is pressurized and fed into the bottom of a scrubber column while the scrubber input liquid is fed to the top of the column, so that absorption can occur in a counter-current flow. After contacting the biogas and absorbing CO₂, volatile organic compounds (VOCs), and H₂S, scrubber output liquid exits the bottom of the scrubber column. The scrubber output liquid must then be regenerated before it can be used again as scrubber input liquid. That is, the absorbed CO₂, volatile organic compounds (VOCs), and H₂S in the scrubber output liquid must be reduced (preferably to near zero) before the scrubber liquid can be reused to absorb more CO₂, volatile organic compounds (VOCs), and H₂S.

Prior methods of removing CO₂, volatile organic compounds (VOCs), and H₂S from the scrubber liquid are similar to those used to remove the same compounds from unprocessed biogas. In particular, the scrubber output liquid (i.e. the contaminated scrubber liquid) is fed into the top of a stripper column while air is fed to the bottom of the column, so that the scrubber output liquid and the air are in a counter-current flow. Passing air through the scrubber output liquid encourages degassing, with the liberated CO₂, volatile organic compounds (VOCs), and H₂S carried out of the stripper tank with the air as off-gas. The scrubber output liquid then pools at the bottom of the stripper tank and is pumped through the scrubber tank again.

However, using airflow to degas the scrubber gas is not without problems. For instance, a significant air flow is required to effectively strip contaminants from the scrubber liquid. This alone imposes physical requirements on the biogas processing apparatus, necessitating sufficiently large pumps, pipes, etc., to handle a large volume of off-gas at a significantly high flow rate. These physical requirements add complexity and cost to the system.

Further, CO₂ and H₂S are not the only species absorbed by the stripper liquid from the biogas. Namely, some amount of CH₄ is also absorbed. Regeneration of the stripper liquid liberates the absorbed CH₄, which is then contained in an off-gas. It is highly undesirable to release CH₄ into the atmosphere, so it is typically more desirable to burn or oxidize CH₄ in the off-gas rather than release it into the atmosphere. However, CH₄ in the off-gas has been diluted by such a large volume of air that burning CH₄ in the off-gas is difficult without supplementing the off-gas flow with additional fuel. Adding additional fuel adds cost and decreases efficiency.

As an alternative to burning the CH₄ in the off-gas, the off-gas may be subjected to a regenerative or non-regenerative thermal oxidizer. Again, the large volume and high flow rate of the off-gas impose physical requirements on suitable regenerative thermal oxidizers, which must be large enough and have sufficient capacity to process the entire off-gas flow. These physical requirements add complexity and cost to the system.

Described herein are methods and systems that reduce or eliminate airflow in the stripper system, and thus reduce or eliminate airflow in the off-gas from the stripper system. In some embodiments, reduction or elimination of airflow in the off-gas is accomplished by subjecting the scrubber output liquid to a negative pressure (e.g. applied by an upstream pump, such as a vacuum blower), in conjunction with agitation of the scrubber output liquid and/or increasing the surface area of the scrubber output liquid while it is subjected to the negative pressure. This negative pressure serves to encourage degassing of the scrubber liquid.

In other embodiments, airflow in the off-gas may be reduced, but not eliminated, by supplementing an airflow stripper system, as described above, with agitation of the scrubber output liquid and/or increasing the surface area of the scrubber output liquid in contact with the airflow through the stripper column.

### Agitation of Scrubber Liquid Through Off-Gas Recirculation

In embodiments where the scrubber output liquid is agitated, the agitation may be accomplished in a number of ways. For example, in some embodiments, scrubber output liquid in the stripper column is agitated by diverting a portion of the stripper column off-gas and introducing the diverted off-gas back through the stripper column. In these embodiments, the diverted off-gas is introduced into the bottom of the stripper column, so that the scrubber output liquid and the diverted off-gas are in a counter-current flow. In embodiments where negative pressure is applied to the stripper column, the diverted off-gas is split from the main off-gas flow at some point after the upstream pump. Passing the diverted off-gas through the scrubber output liquid further encourages degassing, with the liberated CO₂, volatile organic compounds (VOCs), and H₂S carried out of the stripper tank without being diluted by air.

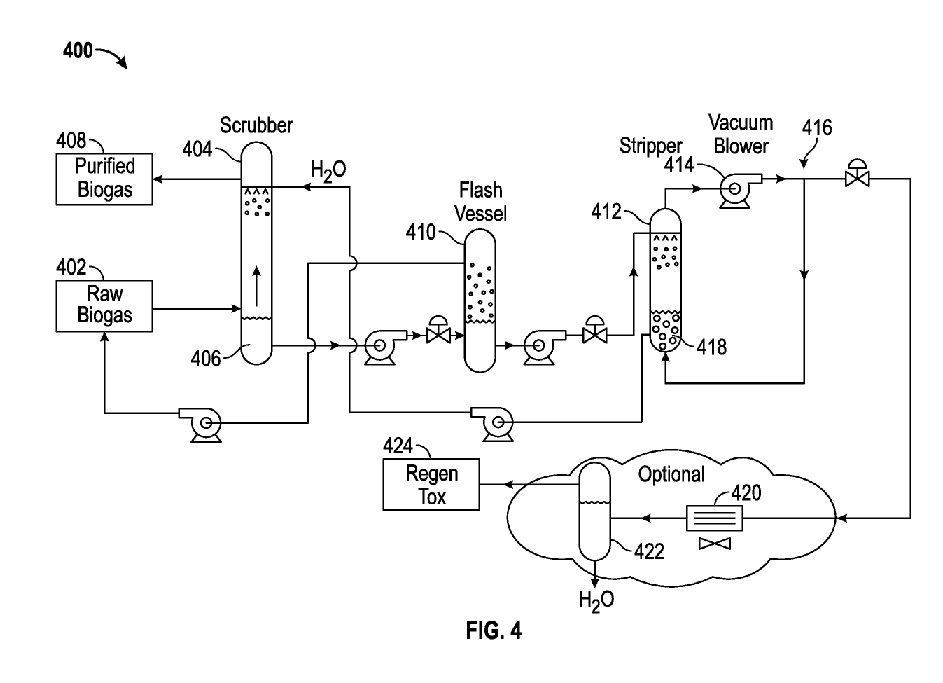

One exemplary system of this embodiment is seen in FIG. 4, which is a flow diagram illustrating a gas processor of the instant invention. The exemplary gas processor shown in FIG. 4 utilizes negative pressure and a recirculating portion of the off-gas flow to reduce CO₂, volatile organic compounds (VOCs), and H₂S in the scrubber liquid. In particular, a biogas input flow 402 at approximately 125 psi enters the gas processor 400 and is introduced into the scrubber tank 404 at or near the bottom of the scrubber tank 404. A scrubber liquid 406 is also introduced into the scrubber tank 402 at or near the top of the scrubber tank 402, so that the biogas input flow 402 and scrubber liquid 406 are in contact in a counter-current flow. Through this contact, CO₂, volatile organic compounds (VOCs), and H₂S from the biogas input flow 402 are absorbed by the scrubber liquid 406. A purified biogas output flow 408 exits at or near the top of the scrubber tank 402 and is optionally subjected to additional processing (e.g., as seen in FIG. 3).

Referring again to the exemplary system depicted in FIG. 4, the scrubber liquid 406 is collected at the bottom of the scrubber tank 402 and is pumped to a flash vessel 410, where the majority of CH₄ absorbed by the scrubber liquid 406 is removed and returned to the biogas input flow 402. The scrubber liquid 406 is then pumped from the flash vessel 410 into the stripper column 412. Scrubber liquid 406 enters into an upper portion, falls, and collects in a lower portion of the stripper column 412. Throughout this process, the contents of the stripper column 412 are subjected to a negative pressure applied by a vacuum blower 414. The negative pressure encourages evolution of CO₂, volatile organic compounds (VOCs), and H₂S from the scrubber liquid 406, and the evolved gases flow out of the stripper tank 412 as an off-gas flow.

In the exemplary system depicted in FIG. 4, a portion of the off-gas flow is diverted at diversion point 416 and reintroduced at or near the bottom of the stripper tank 412. The entry point into the stripper tank 412 is such that the diverted off-gas bubbles through scrubber liquid 418. The bubbling action of the diverted off-gas flow through the scrubber liquid 418 agitates the pooled scrubber liquid 418, encouraging off-gassing of residual CO₂, volatile organic compounds (VOCs), and H₂S in the scrubber liquid 418.

The non-diverted portion of the off-gas flow is then optionally subjected to additional processing, such as biological sulfur removal (e.g., seen in FIG. 3 at element 334 and in FIG. 4 at element 420), drying (e.g., seen in FIG. 3 at element 338 and in FIG. 4 at element 422), and regenerative thermal oxidation (e.g., seen in FIG. 3 at element 344 and in FIG. 4 at element 424).

### Agitation of Scrubber Liquid Through Mechanical Agitation or Liquid Recirculation

In addition or in the alternative, scrubber output liquid in the stripper column may be agitated by other means of mixing or agitating liquids known in the art, such as by mechanical or fluid manipulation means (e.g., with a propeller, an impeller, a turbine, or recirculating (i.e., removing and reintroducing) a portion of the scrubber output liquid). Thus, some embodiments require that the stripper system comprise one or more additional subsystems to accomplish agitation. In some embodiments, these subsystems comprises one or more of a propeller, impeller, turbine, a pump to recirculate a portion of the pooled scrubber output liquid (with or without one or more eductors, nozzles, or other fluid flow regulation devices), and the like.

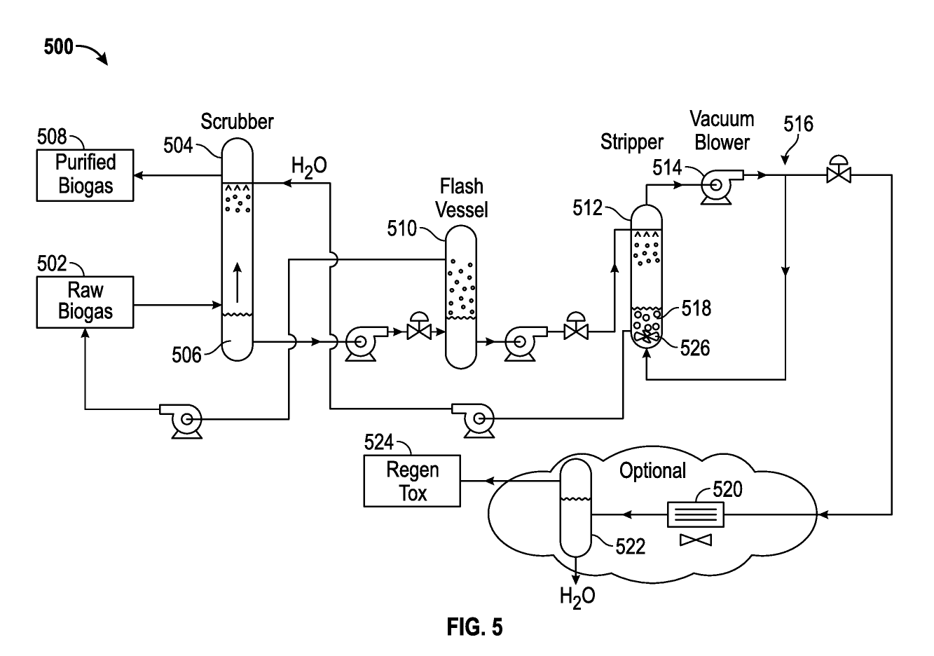

One exemplary system of this embodiment is seen in FIG. 5, which is a flow diagram illustrating a gas processor of the instant invention. The exemplary gas processor shown in FIG. 5 utilizes negative pressure, a recirculating portion of the off-gas flow, and mechanical agitation to reduce CO₂, volatile organic compounds (VOCs), and H₂S in the scrubber liquid. In particular, a biogas input flow 502 at approximately 125 psi enters the gas processor 500 and is introduced into the scrubber tank 504 at or near the bottom of the scrubber tank 504. A scrubber liquid 506 is also introduced into the scrubber tank 502 at or near the top of the scrubber tank 502, so that the biogas input flow 502 and scrubber liquid 506 are in contact in a counter-current flow. Through this contact, CO₂, volatile organic compounds (VOCs), and H₂S from the biogas input flow 502 are absorbed by the scrubber liquid 506. A purified biogas output flow 508 exits at or near the top of the scrubber tank 502 and is optionally subjected to additional processing (e.g., as seen in FIG. 3).

Referring again to the exemplary system depicted in FIG. 5, the scrubber liquid 506 is collected at the bottom of the scrubber tank 502 and is pumped to a flash vessel 510, where the majority of CH₄ absorbed by the scrubber liquid 508 is removed and returned to the biogas input flow 502. The scrubber liquid 506 is then pumped from the flash vessel 510 into the stripper column 512. Scrubber liquid 506 enters into an upper portion, falls, and collects in a lower portion of the stripper column 512. Throughout this process, the contents of the stripper column 512 are subjected to a negative pressure applied by a vacuum blower 514. The negative pressure encourages evolution of CO₂, volatile organic compounds (VOCs), and H₂S from the scrubber liquid 508, and the evolved gases flow out of the stripper tank 512 as an off-gas flow.

In the exemplary system depicted in FIG. 5, a portion of the off-gas flow is diverted at diversion point 516 and reintroduced at or near the bottom of the stripper tank 512. The entry point into the stripper tank 512 is such that the diverted off-gas bubbles through scrubber liquid 518. The bubbling action of the diverted off-gas flow through the scrubber liquid 518 agitates the pooled scrubber liquid 518. Additionally, the scrubber liquid 518 is further agitated by mechanical agitator 526, such as with a propeller, impellor, turbine, or the like. This combined agitation encourages off-gassing of residual CO₂, volatile organic compounds (VOCs), and H₂S in the scrubber liquid 518, allowing for regeneration of the scrubber liquid 506 without use of an airflow to strip CO₂, volatile organic compounds (VOCs), and H₂S.

The non-diverted portion of the off-gas flow is then optionally subjected to additional processing, such as biological sulfur removal (e.g., seen in FIG. 3 at element 334 and in FIG. 5 at element 520), drying (e.g., seen in FIG. 3 at element 338 and in FIG. 5 at element 522), and regenerative thermal oxidation (e.g., seen in FIG. 3 at element 344 and in FIG. 5 at element 524).

### Increasing Surface Area of Scrubber Liquid Through Recirculation of Scrubber Liquid in the Scrubber Tank

In embodiments where the surface area of the scrubber output liquid is increased, this increase in surface area may also be accomplished in a number of ways. For example, in some embodiments, a portion of scrubber output liquid is removed from the bottom and reintroduced into the stripper tank at some level above the level of scrubber fluid in the stripper tank. Preferably the removed scrubber output liquid is reintroduced into the stripper tank through one or more nozzles or other fluid flow regulation devices such that the scrubber output liquid is reintroduced as a collection of droplets. This collection of droplets has a significantly higher surface area than the bulk liquid, thus subjecting a greater surface area to the negative pressure in the stripper column.

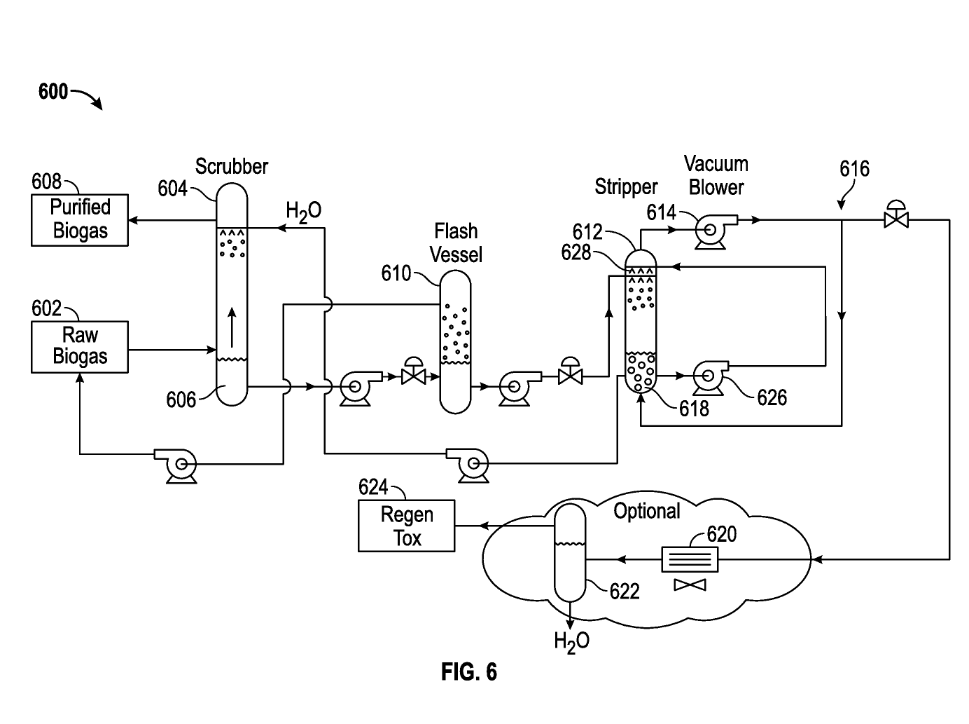

One exemplary system of this embodiment is seen in FIG. 6, which is a flow diagram illustrating a gas processor of the instant invention. The exemplary gas processor shown in FIG. 6 utilizes negative pressure, a recirculating portion of the off-gas flow, and mechanical agitation to reduce CO₂, volatile organic compounds (VOCs), and H₂S in the scrubber liquid. In particular, a biogas input flow 602 at approximately 125 psi enters the gas processor 600 and is introduced into the scrubber tank 604 at or near the bottom of the scrubber tank 604. A scrubber liquid 606 is also introduced into the scrubber tank 602 at or near the top of the scrubber tank 602, so that the biogas input flow 602 and scrubber liquid 606 are in contact in a counter-current flow. Through this contact, CO₂, volatile organic compounds (VOCs), and H₂S from the biogas input flow 602 are absorbed by the scrubber liquid 606. A purified biogas output flow 608 exits at or near the top of the scrubber tank 602 and is optionally subjected to additional processing (e.g., as seen in FIG. 3).

Referring again to the exemplary system depicted in FIG. 6, the scrubber liquid 606 is collected at the bottom of the scrubber tank 602 and is pumped to a flash vessel 610, where the majority of CH₄ absorbed by the scrubber liquid 608 is removed and returned to the biogas input flow 602. The scrubber liquid 606 is then pumped from the flash vessel 610 into the stripper column 612. Scrubber liquid 606 enters into an upper portion, falls, and collects in a lower portion of the stripper column 612. Throughout this process, the contents of the stripper column 612 are subjected to a negative pressure applied by a vacuum blower 614. The negative pressure encourages evolution of CO₂, volatile organic compounds (VOCs), and H₂S from the scrubber liquid 608, and the evolved gases flow out of the stripper tank 612 as an off-gas flow.

In the exemplary system depicted in FIG. 6, a portion of the off-gas flow is diverted at diversion point 616 and reintroduced at or near the bottom of the stripper tank 612. The entry point into the stripper tank 612 is such that the diverted off-gas bubbles through scrubber liquid 618. The bubbling action of the diverted off-gas flow through the scrubber liquid 618 agitates the pooled scrubber liquid 618. Additionally, a second pump system 626 removes a portion of the scrubber liquid 618 and reintroduces the removed scrubber liquid into the stripper tank 612 at a point above the level of scrubber liquid 618 remaining in the stripper tank 612. Preferably, the removed scrubber liquid is reintroduced at or near the top of the stripper tank 612. It is also preferable that the removed scrubber liquid is reintroduced into the stripper tank 612 as a collection of droplets. This collection of droplets may be produced by reintroducing the removed scrubber fluid into the stripper tank 612 through one or more nozzles or other fluid flow regulation devices 628. The collection of droplets has a significantly higher surface area than an equivalent amount of bulk liquid, thus increasing the effect of negative pressure on the evolution of absorbed gasses. Thus, the increased surface area of the scrubber fluid 618 combined with agitation from the recycled off-gas flow encourages off-gassing of residual CO₂, volatile organic compounds (VOCs), and H₂S in the scrubber liquid 618, allowing for regeneration of the scrubber liquid 506 without use of an airflow to strip CO₂, volatile organic compounds (VOCs), and H₂S.

The non-diverted portion of the off-gas flow is then optionally subjected to additional processing, such as biological sulfur removal (e.g., seen in FIG. 3 at element 334 and in FIG. 6 at element 620), drying (e.g., seen in FIG. 3 at element 338 and in FIG. 6 at element 622), and regenerative thermal oxidation (e.g., seen in FIG. 3 at element 344 and in FIG. 6 at element 624).

Increasing Surface Area of Scrubber Liquid Through Introduction of Scrubber Liquid into the Scrubber Tank as a Collection of Droplets

In some embodiments where the surface area of the scrubber output liquid is increased, scrubber output liquid transported from the scrubber tank may be introduced into the stripper column as a collection of droplets. Preferably the scrubber output liquid is introduced into the stripper tank near the top of the tank through one or more nozzles or other fluid flow regulation devices such that the scrubber output liquid is sprayed into the stripper column as a collection of droplets. This collection of droplets has a high surface area, thus subjecting a greater surface area to the reduced pressure in the stripper column.

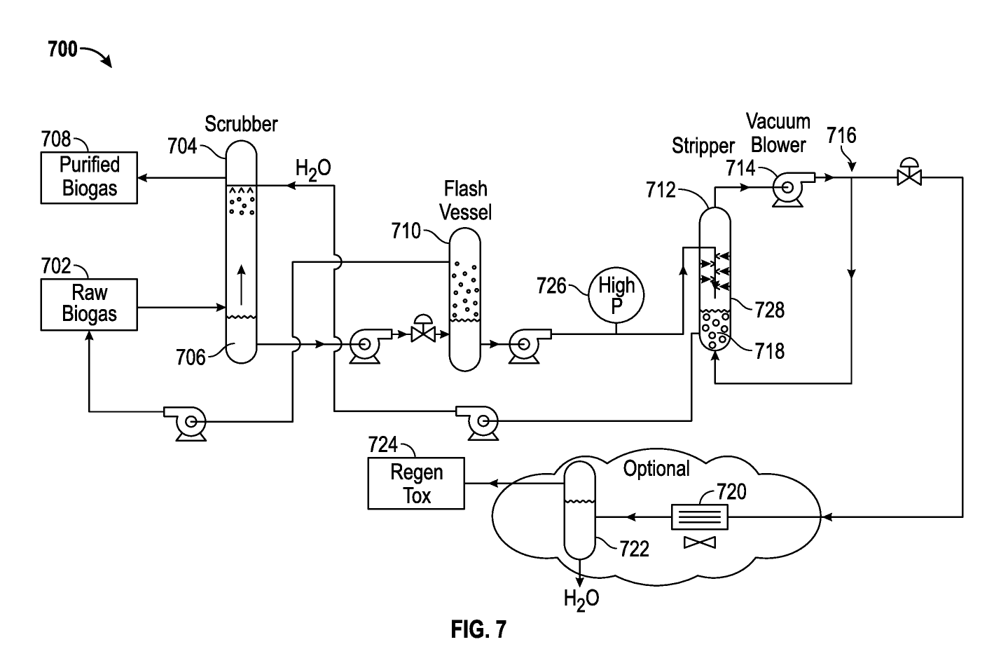

One exemplary system of this embodiment is seen in FIG. 7, which is a flow diagram illustrating a gas processor of the instant invention. The exemplary gas processor shown in FIG. 7 utilizes negative pressure, a recirculating portion of the off-gas flow, and mechanical agitation to reduce CO₂, volatile organic compounds (VOCs), and H₂S in the scrubber liquid. In particular, a biogas input flow 702 at approximately 125 psi enters the gas processor 700 and is introduced into the scrubber tank 704 at or near the bottom of the scrubber tank 704. A scrubber liquid 706 is also introduced into the scrubber tank 702 at or near the top of the scrubber tank 702, so that the biogas input flow 702 and scrubber liquid 706 are in contact in a counter-current flow. Through this contact, CO₂, volatile organic compounds (VOCs), and H₂S from the biogas input flow 702 are absorbed by the scrubber liquid 706. A purified biogas output flow 708 exits at or near the top of the scrubber tank 702 and is optionally subjected to additional processing (e.g., as seen in FIG. 3).

Referring again to the exemplary system depicted in FIG. 7, the scrubber liquid 706 is collected at the bottom of the scrubber tank 702 and is pumped to a flash vessel 710, where the majority of CH₄ absorbed by the scrubber liquid 708 is removed and returned to the biogas input flow 702. The scrubber liquid 706 is then pumped from the flash vessel 710 into the stripper column 712. Scrubber liquid 706 enters into an upper portion, falls, and collects in a lower portion of the stripper column 712. In this embodiment, a second pump system 726 is used to introduce the scrubber liquid 706 into the stripper column 712, under increased pressure, through one or more nozzles or other fluid flow regulation devices 728 which break-up the scrubber liquid 706 into a collection of droplets as it enters the stripper tank 712. Throughout this process, the contents of the stripper column 712 are subjected to a negative pressure applied by a vacuum blower 714. The negative pressure encourages evolution of CO₂, volatile organic compounds (VOCs), and H₂S from the scrubber liquid 708, and the evolved gases flow out of the stripper tank 712 as an off-gas flow. A collection of droplets has a significantly higher surface area than an equivalent amount of bulk liquid, thus increasing the effect of negative pressure on the evolution of absorbed gasses.

In the exemplary system depicted in FIG. 7, a portion of the off-gas flow is also diverted at diversion point 716 and reintroduced at or near the bottom of the stripper tank 712. The entry point into the stripper tank 712 is such that the diverted off-gas bubbles through scrubber liquid 718. The bubbling action of the diverted off-gas flow through the scrubber liquid 718 agitates the pooled scrubber liquid 718, further encouraging off-gassing of residual CO₂, volatile organic compounds (VOCs), and H₂S in the scrubber liquid 718, allowing for regeneration of the scrubber liquid 506 without use of an airflow to strip CO₂, volatile organic compounds (VOCs), and H₂S.

The non-diverted portion of the off-gas flow is then optionally subjected to additional processing, such as biological sulfur removal (e.g., seen in FIG. 3 at element 334 and in FIG. 7 at element 720), drying (e.g., seen in FIG. 3 at element 338 and in FIG. 7 at element 722), and regenerative thermal oxidation (e.g., seen in FIG. 3 at element 344 and in FIG. 7 at element 724).

### Combinations of the Above Systems and Methods

While certain embodiments may only use only a single means of agitation or increasing surface area, it is not intended that any single means or process must be used in isolation. Rather, it is intended that multiple means to accomplish agitation and increasing surface area of the scrubber output liquid may be used in any combination without limit. For example, in certain embodiments, agitation may be accomplished by two or more means, such as recirculating a portion of the off-gas, as described above, in combination with agitating scrubber fluid in the stripper tank by mechanical or other fluid manipulation means, also as described above. Likewise, in certain embodiments, agitation may be used in combination with increasing surface area of the scrubber output fluid. For example, in certain embodiments, scrubber liquid may be agitated by recirculating a portion of the off-gas, as described above, and the surface are of the scrubber liquid may be increased by recirculating a portion of the scrubber liquid from the stripper tank with reintroduction of the recirculated portion as a spray (i.e., as a collection of droplets).

Finally, in some embodiments, one or more means of agitating and/or increasing surface area of the scrubber liquid may be used in conjunction with some airflow through the stripper column. Although it is preferable to completely eliminate airflow from the stripper system, certain benefits can be gained by reducing the amount of airflow necessary in a stripper system by augmenting the airflow stripper system with one or more of scrubber fluid agitation and/or surface area increase.

### Effects of Reducing or Eliminating Airflow in Off-Gas Stream

Reduction or elimination of air from the off-gas flow has several benefits in the processing of biogas. First, reduction or elimination of air allows for use of smaller, and thus less expensive, downstream piping for the off-gas line. Second, reduction or elimination of air results in a potentially significant reduction of the total volume and flow of off-gas. This allows for use of a much smaller, and thus less expensive, thermal oxidizer for processing off-gas to remove residual CH₄. Third, because residual CH₄ in the off-gas is not being effectively diluted by the addition of air, residual CH₄ is significantly more concentrated in the off-gas. Residual CH₄ is easier to combust (e.g., requires less, if any, secondary fuel input) at these higher concentrations. Table 1, below, demonstrates the effect on the concentrations and flow rates of an off-gas stream with air added at 2716 SCFM, and without air being added.

TABLE 1
Effect of elimination of air from stripper off-gas

| | Composition and | | | | Composition and | |
|---|---|---|---|---|---|---|
| | flow (including | | Contribution from | | flow (without air | |
| | air addition) | | air addition | | addition) | |
| | | Flow rate | | Flow rate | | Flow rate |
| Specie | % | (SCFM) | % | (SCFM) | % | (SCFM) |
| CH₄ | 0.7 | 30.4 | 0 | 0 | 1.9 | 30.4 |
| CO₂ | 34.6 | 1504.8 | 0 | 0 | 92.1 | 1504.8 |
| N₂ | 51.1 | 2222.3 | 79 | 2145.6 | 4.7 | 76.7 |
| O₂ | 13.6 | 591.5 | 21 | 570.4 | 1.3 | 21.1 |
| H₂S | 0 | 0.4 | 0 | 0 | 0 | 0.4 |
| Totals | 100 | 4349 | 100 | 2716 | 100 | 1633 |

As seen in Table 1, elimination of air from the off-gas flow results in an increase in the concentration of CH4 in the off-gas from about 0.7 to about 1.9%, and the total off-gas flow is reduced from about 4349 SCFM to about 1633 SCFM.

Off-gas (including the VOCs and H₂S) produced with reduced or eliminated air flow to the stripper tank can be subjected to further processing as known in the art. For example, off-gas may be sent to an optional biological sulfur (i.e., H₂S) removal system. This system may comprise a biological system featuring a solid or liquid sorption process. Alternatively, or in addition, the off-gas is also optionally passed to a regenerative thermal oxidizer, non-regenerative thermal oxidizer, flame, or to an engine for electricity.

In accordance with embodiments of the present invention, air has been reduced or eliminated in the off-gas; thus, insufficient oxygen may be present for a biological H₂S removal system to be effective. As such, the biological H₂S removal system may include air addition (e.g., via blower or compressor) that allows for the proper metering of air into the off-gas stream to achieve the correct concentration for biological use before release into the atmosphere or destruction. Alternatively, a different source of oxygen may be employed in lieu of or in addition to the air addition.

Similarly, the amounts of oxygen and CH₄, or other fuel, in the off-gas may be adjusted prior to optionally processing the off-gas with a regenerative thermal oxidizer, non-regenerative thermal oxidizer, flame, engine, or the like.

One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

1. A system for the purification of biogas, comprising:
a gas processor for reducing CO₂, volatile organic compounds, and H₂S in the biogas, the gas processor comprising a scrubber tank and a scrubber liquid; and
a scrubber liquid processor in fluid connection with the gas processor for reducing the amount of absorbed gas in the scrubber liquid, the scrubber liquid processor comprising:
a stripper tank;
an off-gas pump configured such that the contents of the stripper tank are subjected to a negative pressure and off-gas is removed from the stripper tank; and
off-gas piping configured to divert a portion of the off-gas flow and reintroduce the diverted off-gas flow into the stripper tank such that the reintroduced off-gas flow passes through scrubber liquid contained in the stripper tank.

2. The system of claim 1, wherein the scrubber liquid processor further comprises an agitation device located in said stripper tank, and wherein said agitation device is configured to agitate scrubber liquid contained in the stripper tank.

3. The system of claim 2, wherein said agitation device comprises one or more mechanical agitation devices selected from the group consisting of a propeller, an impellor, and a turbine, and wherein said mechanical agitation device is in contact with scrubber liquid in said stripper tank.

4. The system of claim 1, wherein the scrubber liquid processor further comprises a second pump system in fluid communication with the stripper tank, and wherein said second pump system is configured to remove scrubber liquid from the stripper tank and reintroduce the removed scrubber liquid into the stripper tank in such a way as to agitate the remaining scrubber liquid contained in the stripper tank.

5. The system of claim 4, wherein said second pump system is configured to reintroduce the removed scrubber liquid into the stripper tank through one or more eductors, nozzles, or other fluid flow regulation devices.

6. The system of claim 1, wherein the scrubber liquid processor further comprises a third pump system in fluid communication with the stripper tank, and wherein said third pump system is configured to remove scrubber liquid from the stripper tank and reintroduce the removed scrubber liquid into the stripper tank as droplets at some position above the level of scrubber liquid remaining in the stripper tank.

7. The system of claim 6, wherein the third pump system comprises one or more nozzles or other fluid flow regulation devices through with the reintroduced scrubber liquid is passed to form droplets in the stripper tank.

8. The system of claim 1, wherein the scrubber liquid processor further comprises a fourth pump system in fluid communication with the scrubber tank and the stripper tank; wherein said fourth pump system is configured to transport scrubber liquid from the scrubber tank to the stripper tank after CO₂, volatile organic compounds, and H₂S have been absorbed by the scrubber liquid.

9. The system of claim 8, wherein the fourth pump system is configured to introduce scrubber liquid into the stripper tank as droplets at some position above the level of scrubber liquid in the stripper tank.

10. The system of claim 9, wherein the fourth pump system comprises one or more nozzles or other fluid flow regulation devices through with the scrubber liquid is passed to form droplets in the stripper tank.

11. The system of claim 1, wherein the system further comprises a biological sulfur removal system configured to receive non-diverted off-gas flow from the off-gas pump.

12. The system of claim 11, wherein the biological sulfur removal system comprises air piping configured to allow metered addition of air to the off-gas flow prior to biological sulfur removal.

13. The system of claim 1, wherein the system further comprises a regenerative thermal oxidizer, non-regenerative thermal oxidizer, flame, or engine for oxidation or combustion of residual methane in a non-diverted portion of the off-gas flow.

14. A system for the purification of biogas, comprising:
a gas processor for reducing CO₂, volatile organic compounds, and H₂S in the biogas, the gas processor comprising a scrubber tank and a scrubber liquid; and
a scrubber liquid processor in fluid connection with the gas processor for reducing the amount of absorbed gas in the scrubber liquid, the scrubber liquid processor comprising:
a stripper tank;
an off-gas pump configured such that the contents of the stripper tank are subjected to a negative pressure and off-gas is removed from the stripper tank; and
an agitation device located in said stripper tank,
wherein said agitation device is configured to agitate scrubber liquid contained in the stripper tank.

15. The system of claim 14, wherein said agitation device is a mechanical agitation device.

16. The system of claim 15, wherein said mechanical agitation device is selected from the group consisting of a propeller, an impellor, and a turbine, and wherein the mechanical agitation device is in contact with scrubber liquid in said stripper tank.

17. A system for the purification of biogas, comprising:
a gas processor for reducing CO₂, volatile organic compounds, and H₂S in the biogas, the gas processor comprising a scrubber tank and a scrubber liquid; and
a scrubber liquid processor in fluid connection with the gas processor for reducing the amount of absorbed gas in the scrubber liquid, the scrubber liquid processor comprising:
a stripper tank;
an off-gas pump configured such that the contents of the stripper tank are subjected to a negative pressure and off-gas is removed from the stripper tank; and
a second pump system in fluid communication with the stripper tank,
wherein said second pump system is configured to remove scrubber liquid from the stripper tank and reintroduce the removed scrubber liquid into the stripper tank in such a way as to agitate the remaining scrubber liquid contained in the stripper tank.

18. The system of claim 17, wherein said second pump system is configured to reintroduce the scrubber liquid to the stripper tank through one or more eductors, nozzles, or other fluid flow regulation devices.

19. A system for the purification of biogas, comprising:
a gas processor for reducing CO₂, volatile organic compounds, and H₂S in the biogas, the gas processor comprising a scrubber tank and a scrubber liquid; and
a scrubber liquid processor in fluid connection with the gas processor for reducing the amount of absorbed gas in the scrubber liquid, the scrubber liquid processor comprising:
a stripper tank;
an off-gas pump configured such that the contents of the stripper tank are subjected to a negative pressure and off-gas is removed from the stripper tank; and
a second pump system in fluid communication with the stripper tank,
wherein said second pump system is configured to remove scrubber liquid from the stripper tank and reintroduce the removed scrubber liquid into the stripper tank as droplets at some position above the level of scrubber liquid remaining in the stripper tank.

20. The system of claim 19, wherein the second pump system comprises one or more nozzles or other fluid flow regulation devices through which the scrubber liquid is passed to form droplets in the stripper tank.

21. A system for the purification of biogas, comprising:
a gas processor for reducing CO₂, volatile organic compounds, and H₂S in the biogas, the gas processor comprising a scrubber tank and a scrubber liquid; and
a scrubber liquid processor in fluid connection with the gas processor for reducing the amount of absorbed gas in the scrubber liquid, the scrubber liquid processor comprising:
a stripper tank;
an off-gas pump configured such that the contents of the stripper tank are subjected to a negative pressure and off-gas is removed from the stripper tank; and
a second pump system in fluid communication with the scrubber tank and the stripper tank,
wherein said second pump system is configured to transport scrubber liquid from the scrubber tank to the stripper tank after CO₂, volatile organic compounds, and H₂S have been absorbed by the scrubber liquid, and introduce the transported scrubber liquid into the stripper tank as droplets at some position above the level of scrubber liquid in the stripper tank.

22. The system of claim 21, wherein the second pump system comprises one or more nozzles or other fluid flow regulation devices through which the scrubber liquid is passed to form droplets in the stripper tank.

23. A method for the purification of biogas, comprising:
reducing CO₂, volatile organic compounds, and H₂S, in a biogas by contacting the biogas with a scrubber liquid in a scrubber tank, wherein the scrubber liquid absorbs CO₂, volatile organic compounds, and H₂S from the biogas;
transporting the scrubber liquid from the scrubber tank to a stripper tank;
subjecting the contents of the stripper tank to a negative pressure to evolve an off-gas containing CO₂, volatile organic compounds, and H₂S, from the biogas;
removing the off-gas from the stripper tank;
reintroducing a portion of the removed off-gas to the stripper tank such that the reintroduced off-gas passes through scrubber liquid contained in the stripper tank.

24. The method of claim 23, further comprising agitating scrubber liquid in the stripper tank with a mechanical agitation device.

25. The method of claim 24, wherein said mechanical agitation device is selected from the group consisting of a propeller, an impellor, and a turbine.

26. The method of claim 23, further comprising removing a portion of scrubber liquid from the stripper tank and reintroducing the removed scrubber liquid into the stripper tank in such a way as to agitate the remaining scrubber liquid contained in the stripper tank.

27. The method of claim 26, wherein the removed scrubber liquid is reintroduced to the stripper tank through one or more eductors, nozzles, or other fluid flow regulation devices.

28. The method of claim 23, further comprising removing a portion of scrubber liquid from the stripper tank and reintroducing the removed scrubber liquid to the stripper tank as droplets at some position above the level of scrubber liquid remaining in the stripper tank.

29. The method of claim 28, wherein reintroducing the removed scrubber liquid into the stripper tank as droplets comprises pumping the removed portion through one or more nozzles or other fluid flow regulation devices to form droplets in the stripper tank.

30. The method of claim 23, wherein transporting the scrubber liquid to a stripper tank comprises introducing scrubber liquid from the scrubber tank into the stripper tank as droplets at some position above the level of scrubber liquid in the stripper tank.

31. The method of claim 30, wherein introducing scrubber liquid from the scrubber tank to the stripper tank as droplets comprises pumping the scrubber liquid through one or more nozzles or other fluid flow regulation devices to form droplets.

32. The method of claim 23, further comprising subjecting a portion of the off-gas from the stripper tank to a biological sulfur removal system.

33. The method of claim 23, further comprising subjecting a portion of the off-gas from the stripper tank to a regenerative thermal oxidizer, non-regenerative thermal oxidizer, flame, or engine for oxidation or combustion of residual methane in the off-gas.

34. A method for the purification of biogas, comprising:
reducing CO₂, volatile organic compounds, and H₂S, from a biogas by contacting the biogas with a scrubber liquid in a scrubber tank, wherein the scrubber liquid absorbs CO₂, volatile organic compounds, and H₂S from the biogas;
transporting the scrubber liquid from the scrubber tank to a stripper tank;
subjecting the contents of the stripper tank to a negative pressure and agitation to evolve an off-gas containing CO₂, volatile organic compounds, and H₂S, from the biogas; and
removing the off-gas from the stripper tank.

35. The method of claim 34, wherein agitation of the scrubber liquid is accomplished by a mechanical agitation device.

36. The method of claim 35, wherein said mechanical agitation device is selected from the group consisting of a propeller, an impellor, and a turbine.

37. The method of claim 34, wherein agitation of the scrubber liquid is accomplished by removing a portion of scrubber liquid from the stripper tank and reintroducing the removed scrubber liquid into the stripper tank in such a way as to agitate the remaining scrubber liquid contained in the stripper tank.

38. The method of claim 37, wherein the removed scrubber liquid is reintroduced into the stripper tank through one or more eductors, nozzles, or other fluid flow regulation devices.

39. A method for the purification of biogas, comprising:
reducing CO₂, volatile organic compounds, and H₂S, from a biogas by contacting the biogas with a scrubber liquid in a scrubber tank, wherein the scrubber liquid absorbs CO₂, volatile organic compounds, and H₂S from the biogas;
transporting the scrubber liquid from the scrubber tank to a stripper tank;
subjecting the contents of the stripper tank to a negative pressure to evolve an off-gas containing CO₂, volatile organic compounds, and H₂S, from the biogas;
removing a portion of scrubber liquid in the stripper tank and reintroducing the removed scrubber liquid into the stripper tank as droplets at some position above the level of scrubber liquid remaining in the stripper tank to further evolve off-gas containing CO₂, volatile organic compounds, and H₂S, from the biogas; and
removing the off-gas from the stripper tank.

40. The method of claim 39, wherein reintroducing removed scrubber liquid as droplets comprises pumping the removed scrubber liquid through one or more nozzles or other fluid flow regulation devices to form droplets.

41. A method for the purification of biogas, comprising:
reducing CO₂, volatile organic compounds, and H₂S, from a biogas by contacting the biogas with a scrubber liquid in a scrubber tank, wherein the scrubber liquid absorbs CO₂, volatile organic compounds, and H₂S from the biogas;
transporting the scrubber liquid from the scrubber tank to a stripper tank and introducing the scrubber liquid into the stripper tank as droplets at some position above the level of scrubber liquid in the stripper tank;
subjecting the contents of the stripper tank to a negative pressure to evolve an off-gas containing CO₂, volatile organic compounds, and H₂S, from the biogas.

42. The method of claim 41, wherein introducing the scrubber liquid into the stripper tank as droplets comprises pumping the scrubber liquid through one or more nozzles or other fluid flow regulation devices in the stripper tank to form droplets.
